(19) United States
(12) Patent Application Publication
(10) Pub. No.: US 2003/0220854 A1
(43) Pub. Date: Nov. 27, 2003

(54) Online accounting management system and method

(76) Inventors: Te-Mei Chu, Taipei (TW); Shu-Mei Chien, Taipei (TW); Yun-Chi Lee, Taipei (TW); Kuan-I Wu, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/385,884

(22) Filed: Mar. 11, 2003

(30) Foreign Application Priority Data
May 22, 2002 (TW) 91110757

(51) Int. Cl. G06F 17/60

(52) U.S. Cl. 705/30

(57) ABSTRACT

An online accounting management system and an online accounting management method are provided. In operation, a manufacturer inputs data of products delivered from a material supplier in a day to an accounting management module where the product delivery data are processed to form report data and stored in a database. On the next day, the material supplier can retrieve the report data via a network to thereby make an invoice according to the report data. Real-time provision of the report data allows easy accounting management and needs only one invoice incorporated with all product delivery data per day, thereby reducing costs of human resources and materials.

### FIELD OF THE INVENTION

The present invention relates to online accounting management systems and methods, and more particularly, to an accounting system and method for allowing a material supplier to conveniently make invoices to a manufacturer for purchasing transaction.

### BACKGROUND OF THE INVENTION

A concept of network can be traced back to an ARPAnet project produced by Ministry of National Defense of U.S.A. since mid-1950s, followed by a concept of World Wide Web raised by Tim Berners-Lee since early 1990s and subsequent rapid development of Internet, making Internet create a virtual world in which traditional ways for information retrieval and communication are changed in a manner as to allow almost all types of activities and information to be implemented and obtained through Internet; therefore, Internet has become one of innovative, fast-growing industries.

Generally, business or commercial activities performed though Internet are referred to as “electronic commerce (e-commerce)”, such as information provision, reporting of markets, trading of goods and so on. In compliance with broad application of Internet that speeds up global communication, business or trading is developed over boundaries of countries, making enterprises grow, or expand internationally instead of centrally focusing on a local area or a single country. Electronic commerce can be implemented primarily in several types of operational modes, including a “business to business (B2B)” mode, a “business to customer (B2C)” mode and a “customer to customer (C2C)” mode.

As Internet is advantageous to conduct business performances without time and regional concerns, traditional business or trading activities are modified or evolved to electronically operate via a network. For example of domestic electronic original equipment manufacturer (OEM), they usually have their own purchasing procedures for purchasing assembly parts or elements from material suppliers. FIG. I illustrates a series of conventional purchasing procedures. First, in step 10, a manufacturer makes a purchase order to a material supplier by mail ordering 100, facsimile ordering 101 or electronic-mail (e-mail) ordering 102 via a network. Then, in step 11, upon receiving the purchase order, the material supplier generates a record of product delivery to deliver ordered products to the manufacturer according to the purchase order. In step 12, the manufacturer receives and examines the delivered products; then, in step 13, the manufacturer asks for an invoice from the material supplier according to the delivered products. In step 14, the manufacturer may proceed with subsequent processes related to the invoice.

However, the above conventional purchasing procedures have significant drawbacks as follows.

Firstly, the material supplier needs to make an invoice for each record of product delivery; for example, if the manufacturer receives a set of products with an invoice from the material supplier in the morning of a day, and further receives another set of products from the material supplier in the afternoon of the same day, another invoice should be made for the latter receipt of products; this thereby leads to waste of human resources and materials as to make and forward multiple invoices.

Secondly, as an accounting department of the material supplier repeats making a plurality of invoices per day, inputting data to an accounting system in a computer or filling other documents, such artificial operation would easily cause errors and difficulty in management.

Thirdly, some material suppliers are commodity agents for foreign suppliers from such as U.S.A., and quote foreign commodities in foreign currencies e.g. US dollars; this thereby increases costs of human resources to frequently update commodity prices with the latest currency exchange rates.

### SUMMARY OF THE INVENTION

An objective of the present invention is to provide an online accounting management system and method, which can be time-effective and cost-effective to implement.

Another objective of the invention is to provide an online accounting management system and method, which can effectively reduce costs of human resources and materials.

A further objective of the invention is to provide an online accounting management system and method, which can reduce artificial errors during operation and improve accounting management.

In accordance with the above and other objectives, the present invention proposes an online accounting management system and method. The online accounting management system comprises: Internet for mediating transmission of electronic data; a purchasing terminal comprising at least one purchasing point having a working platform connected to Internet, wherein the working platform allows input of product delivery data and executes programs, and the working platform includes a database for storing data, and an accounting management module for processing the product delivery data into report data that are uploaded to Internet; and a material supplier terminal comprising at least one material supplier having a working platform that is connected to Internet and provided with a browsing module for browsing the report data through Internet.

The online accounting management method comprises the steps of: (1) inputting product delivery data to an accounting management module via a purchasing terminal; (2) processing the product delivery data into report data via the accounting management module, allowing the report data to be stored in a database and uploaded to a material supplier terminal through Internet; and (3) browsing the report data via the material supplier terminal to make an invoice at a predetermined time according to the report data. The above online accounting management system and method provide significant benefits. First, a material supplier only needs to make an invoice incorporated with all product delivery data per day instead of one invoice for each delivery of products, thereby effectively reducing costs of human resources and materials. And, one invoice per day makes accounting management easy to implement and reduces artificial errors. Moreover, the online accounting management system may provide data of foreign currency exchange rates, and thereby improves operational efficiency especially when product prices are quoted in foreign dollars.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a flowchart showing a series of conventional purchasing procedures;

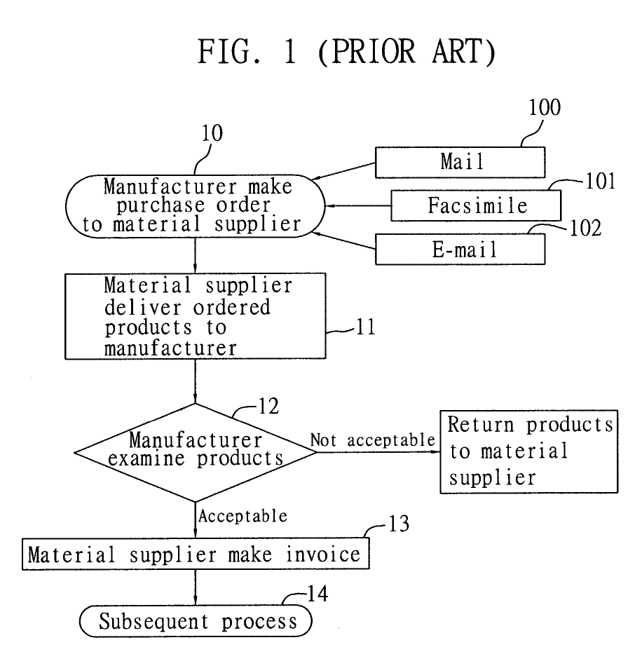

FIG. 2 is a schematic block diagram showing an online accounting management system according to a preferred embodiment the invention;:

FIG. 3 is another schematic block diagram showing the online accounting management system according to the invention;

FIG. 4 is a flowchart showing process steps of an online accounting management method according to a preferred embodiment of the invention;

FIG. 5 is a schematic diagram of a display picture for report search according to the invention;

FIG. 6 is a schematic diagram of a display picture for summary report data according to the invention, and

FIG. 7 is a schematic diagram of a display picture for detailed report data according to the invention.

### DETAILED DESCRIPTION OF THE PREFERRED EMBODIMENTS

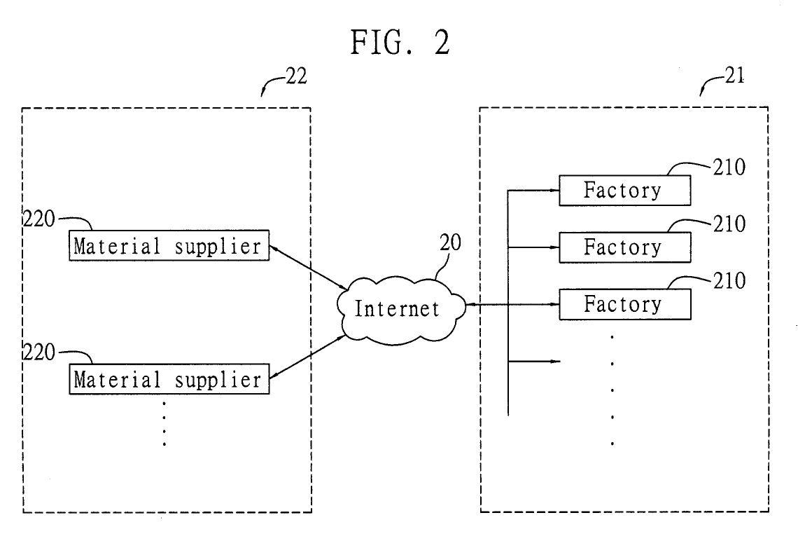

Preferred embodiments of an online accounting management system and method proposed in the present invention are described in detail with reference to FIGS. 2 to 7.

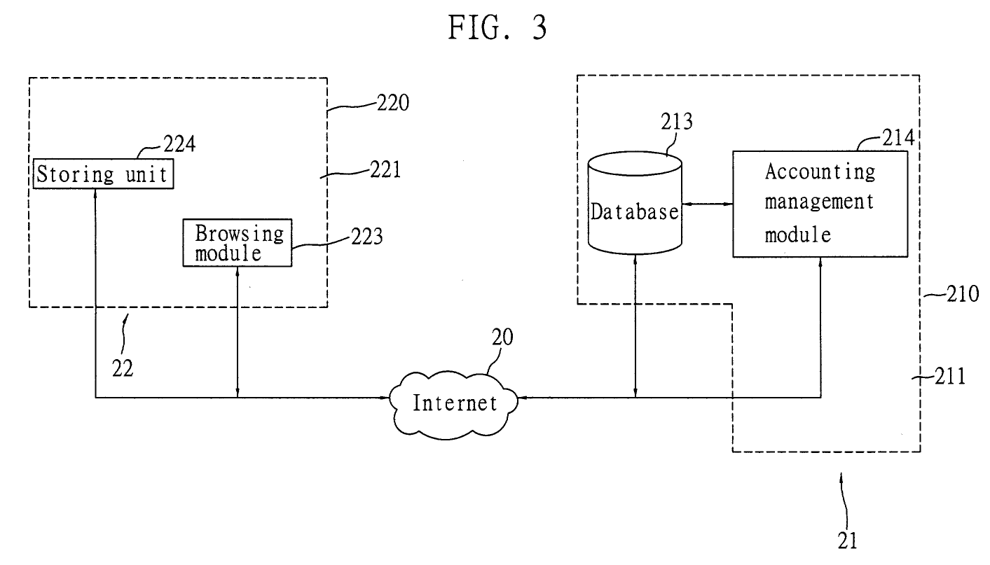

The online accounting management system of this invention is of a B2B (business to business) operational mode, comprising: Internet, a purchasing terminal and a material supplier terminal. FIGS. 2 and 3 illustrate architecture of the online accounting management system according to the invention.

Internet 20 is used to mediate communication of digital information or data.

The purchasing terminal, a manufacture 21 in this embodiment, possesses a plurality of factories 210 (purchasing points), each factory 210 having a working platform 211 connected to Internet 20 by wired or wireless transmission, which is not a key feature of the invention and thereby not to be further described herein. The working platform 211 is used to allow a user to input product delivery data and execute relevant programs and software; the working platform 211 is formed with a database 213 for storing data, and an accounting management module 214 for processing the product delivery data into a report form that is then stored in the database 213 and uploaded to Internet 20.

The material supplier terminal 22 comprises at least one material supplier 220 in this embodiment, wherein the material supplier 220 includes a working platform 221 connected to Internet 20 by wire or wireless transmission, a browsing module 223 for browsing for uploaded report data from Internet 20, and a storing unit 224 for storing report data.

In operation, the user at each factory 210 can input related data of received products delivered from each material supplier 220 in a day to the working platform 211 via an ERP (enterprise resource planning) system, and then, the accounting management module 214 processes the inputted data into a report form to be stored in the database 213 and uploaded through Internet 20 to the working platform 221 of the material supplier 220. On the next day, the material supplier 220 can operate the browsing module 222 to browse report data uploaded from the factory 210, and thereby makes one invoice per day incorporated with all required product-related data.

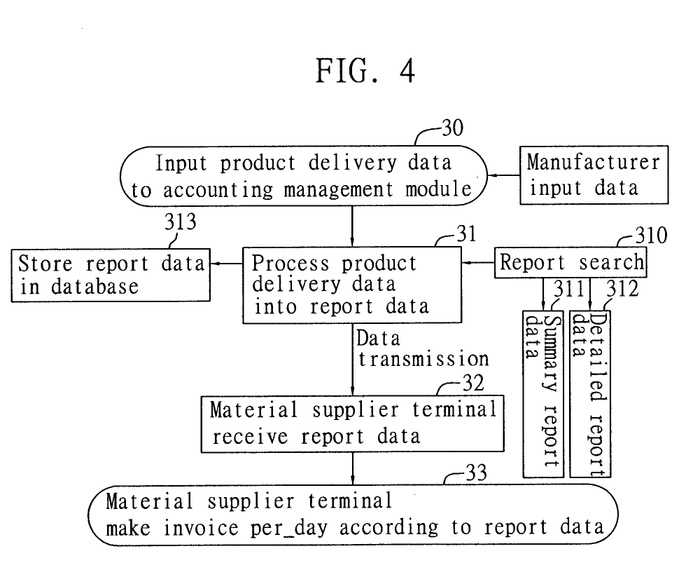

FIG. 4 illustrates process steps of an online accounting management method through the use of the above online accounting management system. As shown in the drawing, in step 30, a manufacturer (purchasing terminal) inputs product delivery data to an accounting management module, which can be connected externally to ERP software for facilitating input of data and information related to product delivery. Then, in step 31, the accounting management module processes the product delivery data into a report form to be stored in a database; the accounting management module further provides a search function for allowing users to optionally search report data, including summary report data and detailed report data. Finally, in steps 32 and 33, report data are transmitted to a material supplier terminal, whereby the material supplier terminal can be connected to Internet for browsing the report data, and thus makes an invoice according to the report data at a predetermined time per day.

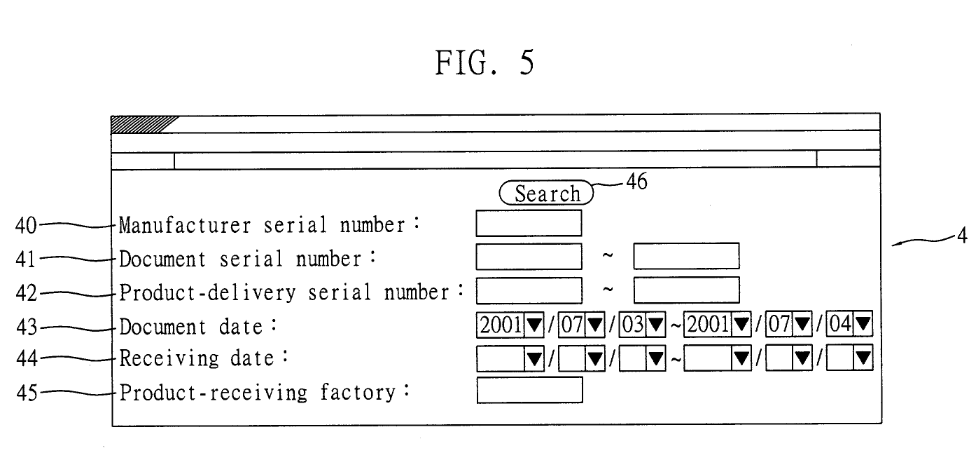

FIG. 5 illustrates a display picture for a report search form 4 according to the invention, which includes fields of manufacturer serial number 40, document serial number 41, product-delivery serial number 42, document date 43, receiving date 44 and product-receiving factory 45, so as to allow users to input data to corresponding fields as a basis or reference for conducting report: searching. For example, if a user intends to search report data with a document date between Jul. 3, 2001 to Jul. 04, 2001, he or she only needs to fill the document date field 43 with the above dates, and then press a button “search” 46 to conduct the search.

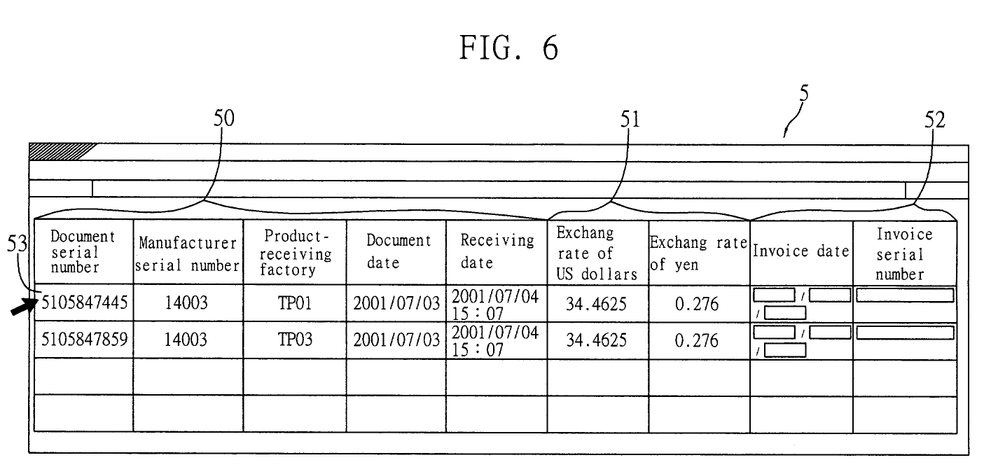

FIG. 6 illustrates a display picture for a summary report 5 according to the invention after initiating the report search shown in FIG. 5. The summary report 5 includes a plurality of standard columns 50 such as document serial number, manufacturer serial number, product-receiving factory, document date, receiving date; foreign currency exchange rate columns 51 for US dollars and yen; and columns 52 of invoice date and invoice serial number for allowing users to input data thereto.

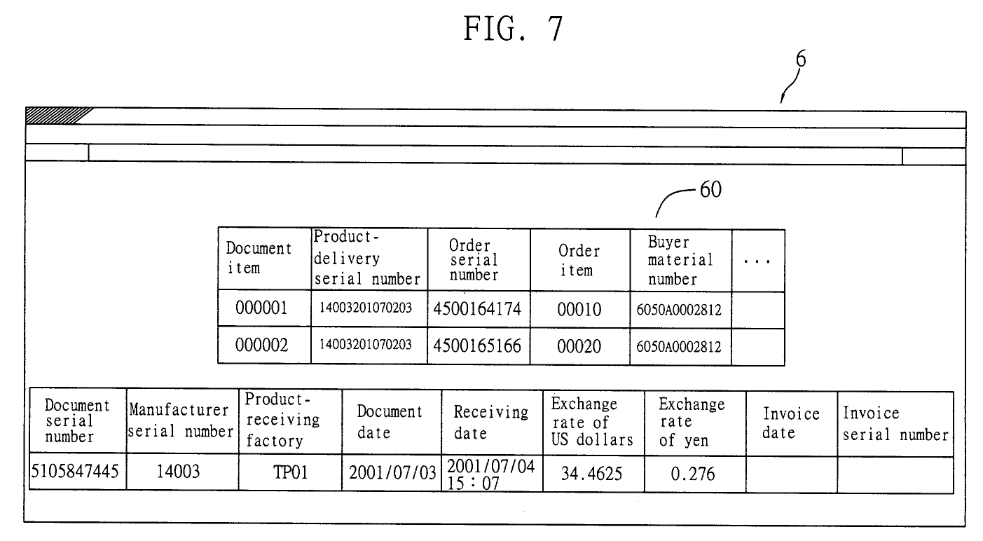

FIG. 7 illustrates a display picture for a detailed report 6 according to the invention. For example, if a user intends to know more details about the document serial number 5105847445 (indicated by an arrow in FIG. 6), he or she can then press the “5105847445” column 53 to thereby show up the detailed report 6 of FIG. 7, including columns 60 related to detailed product delivery data such as document item, product-delivery serial number, order serial number, order item and so on, such that users may obtain detailed information about product delivery.

In conclusion, the online accounting management system and method according to the invention provide significant benefits. First, a material supplier only needs to make an invoice incorporated with all product delivery data per day instead of one invoice for each delivery of products, thereby effectively reducing costs of human resources and materials. And, one invoice per day makes accounting management easy to implement and reduces artificial errors. Moreover, data of foreign currency exchange rates are provided to thereby improve efficiency of the online accounting management system especially when product prices are quoted in foreign dollars.

The invention has been described using exemplary preferred embodiments. However, it is to be understood that the scope of the invention is not limited to the disclosed embodiments. On the contrary, the scope claims should be accorded the broadest interpretation so as to encompass all such modifications and similar arrangements.

What is claimed is:

1. An online accounting management system, comprising:
a network for mediating transmission of electronic data;
a purchasing terminal comprising at least one purchasing point having a working platform connected to the network, wherein the working platform allows input of material delivery data and executes programs, and the working platform includes a database for storing data, and an accounting management module for processing the material delivery data into report data that are uploaded to the network; and
a material supplier terminal comprising at least one material supplier having a working platform connected to the network for browsing the report data.

2. The online accounting management system of claim 1, wherein the purchasing terminal is a manufacturer.

3. The online accounting management system of claim 2, wherein the purchasing point is a factory of the manufacturer.

4. The online accounting management system of claim 1, wherein the report data are of a report search form.

5. The online accounting management system of claim 4, wherein the report search form comprises columns of manufacturer serial number, document serial number, material-delivery serial number, document date, receiving date, material-receiving factory.

6. The online accounting management system of claim 1, wherein the report data are of a summary report.

7. The online accounting management system of claim 1, wherein the report data are of a detailed report.

8. The online accounting management system of claim 6, wherein the summary report comprises at least one column of foreign currency exchange rate.

9. The online accounting management system of claim 8, wherein the column of foreign currency exchange rate is for US dollars.

10. The online accounting management system of claim 8, wherein the column of foreign currency exchange rate is for yen.

11. The online accounting management system of claim 1, wherein the network is Internet.

12. An online accounting management method, comprising the steps of:
(1) inputting material delivery data to an accounting management module via a purchasing terminal,
(2) processing the material delivery data into report data via the accounting management module, allowing the report data to be stored in a database and uploaded to a material supplier terminal through a network, and
(3) browsing the report data via the material supplier terminal to make an invoice at a predetermined time according to the report data.

13. The online accounting management method of claim 12, wherein the accounting management module is connected to ERP (enterprise resource planning) software for facilitating input of data and information related to material delivery.

14. The online accounting management method of claim 12, wherein in step (2), the accounting management module provides a report search function for allowing a user to search intended report data.

15. The online accounting management method of claim 14, wherein the report data are summary report data.

16. The online accounting management method of claim 14, wherein the report data are detailed report data.

17. The online accounting management method of claim 12, wherein in step (3), the material supplier terminal makes one invoice per day.

18. The online accounting management method of claim ]2, wherein the network is Internet.
